(19) United States
(12) Patent Application Publication
(10) Pub. No.: US 2017/0309217 A1
(43) Pub. Date: Oct. 26, 2017

(54) DISPLAY DRIVING DEVICE AND DISPLAY DEVICE INCLUDING THE SAME

(71) Applicant: SILICON WORKS CO., LTD., Daejeon-si (KR)

(72) Inventors: Young Bok KIM, Daejeon-si (KR); Hyun Kyu Jeon, Daejeon-si (KR); Joon Ho Na, Daejeon-si (KR)

(73) Assignee: SILICON WORKS CO., LTD., Daejeon-si (KR)

(21) Appl. No.: 15/492,325

(22) Filed: Apr. 20, 2017

(30) Foreign Application Priority Data
Apr. 22, 2016 (KR) 10-2016-0049519
Apr. 5, 2017 (KR) 10-2017-0044005

(51) Int. Cl. G09G 3/20

(52) U.S. Cl. CPC G09G 3/2092; G09G 2330/021; G09G 2320/041; G09G 2310/0248; G09G 2310/027; G09G 2310/0291

(57) ABSTRACT

A display driving device may include: a source driving channel configured to provide a source driving signal corresponding to image data; a precharge unit configured to precharge a data output line of the source driving channel by selecting one of precharge voltages; and a precharge controller configured to decide whether to perform a precharge operation on the source driving channel depending on a variation of the image data, and control the precharge unit to select one of the precharge voltages when the performance of the precharge operation is decided.

### BACKGROUND

### 1. Technical Field

The present disclosure relates to a display device, and more particularly, to a display driving device capable of reducing power consumption and a display device including the same.

### 2. Related Art

In general, a display driving device refers to a device for driving a display panel. The display driving device converts digital image data into a source driving signal, and provides the source driving signal to the display panel.

The display driving device includes a digital-analog converter for converting digital image data into a source driving signal and an output circuit for transmitting the source driving signal to the display panel.

The output circuit includes an output buffer for buffering the source driving signal and switches for transferring the source driving signal to the display panel.

The conventional display driving device periodically precharges all data output lines to a predetermined level of voltage before transmitting the source driving signal to the display panel, in order to reduce power consumption.

However, since the conventional display driving device precharges all of the data output lines to the predetermined level of voltage regardless of digital image data which are varied with the elapse of time, the display driving device may cause unnecessary power consumption.

Furthermore, since the conventional display driving device precharges all of the data output lines even when digital image data are not varied, the swing of the source driving signal may be rather increased. Thus, power may be unnecessarily consumed.

Therefore, there is a demand for a technique capable of implementing low-power operation by optimizing power consumption for each channel.

### SUMMARY

Various embodiments are directed to a display driving device capable of implement low-power operation by utilizing a precharge voltage suitable for a driving pattern of a source driving panel, and a display device including the same.

In an embodiment, a display driving device may include: a source driving channel configured to provide a source driving signal corresponding to image data; a precharge unit configured to precharge a data output line of the source driving channel by selecting one of precharge voltages; and a precharge controller configured to decide whether to perform a precharge operation on the source driving channel depending on a variation of the image data, and control the precharge unit to select one of the precharge voltages when the performance of the precharge operation is decided.

In an embodiment, a display device may include: a voltage generator configured to generate precharge voltages; source driving channels each including a digital-analog converter configured to convert image data into a source driving signal and an output buffer configured to output the source driving signal to a data output line; a precharge unit configured to precharge the data output line by selecting one of the precharge voltages; and a precharge controller configured to decide whether to perform a precharge operation on each of the source driving channels depending on a variation of the image data, and control the precharge unit to select one of the precharge voltages when the performance of the precharge operation is decided.

In an embodiment, a display driving device may include: a source driving channel configured to provide a source driving signal corresponding to image data in a first driving period; a precharge controller configured to compare the logic level of most significant bits of current image data to the logic level of most significant bits of previous image data in a second driving period, decide whether to perform a precharge operation based on the comparison result, and provide a precharge control signal for selecting a precharge voltage closest to a gray scale corresponding to the current image data when the performance of the precharge operation is decided; and a precharge unit configured to select one of precharge voltages in response to the precharge control signal, and precharge a data output line corresponding to the source driving channel to the selected precharge voltage.

According to the present embodiments, since a precharge voltage suitable for a driving pattern of the source driving channel is utilized, the display driving device and the display device including the same can implement low-power operation.

Furthermore, since the display driving device and the display device decide whether to perform a precharge operation on each of the source driving channel depending on the varied value of image data, the display driving device and the display device can prevent an unnecessary precharge operation, thereby reducing power consumption.

Furthermore, since the display driving device and the display device decide the level of a precharge voltage depending on the value of current data to be applied to each source driving channel, the display driving device and the display device can reduce the swing of the source driving signal, thereby reducing power consumption and heat generation.

Furthermore, since the precharge time is changed depending on the varied value of the image data, the precharge effect can be maximized.

### BRIEF DESCRIPTION OF THE DRAWINGS

FIG. 1 is a block diagram of a display driving device and a display device including the same according to an embodiment of the present invention.

FIG. 2 is a diagram exemplifying that a precharge controller of FIG. 1 decides a precharge voltage level according to the value of digital image data.

FIGS. 3 and 4 are waveform diagrams for describing the operation of the display driving device according to the embodiment of the present invention.

### DETAILED DESCRIPTION

Hereafter, embodiments of the present invention will be described in detail with reference to the accompanying drawings. The terms used in the present specification and claims are not limited to typical dictionary definitions, but must be interpreted into meanings and concepts which coincide with the technical idea of the present invention.

Embodiments described in the present specification and configurations illustrated in the drawings are preferred embodiments of the present invention, and do not represent the entire technical idea of the present invention. Thus, various equivalents and modifications capable of replacing the embodiments and configurations may be provided at the point of time that the present application is filed.

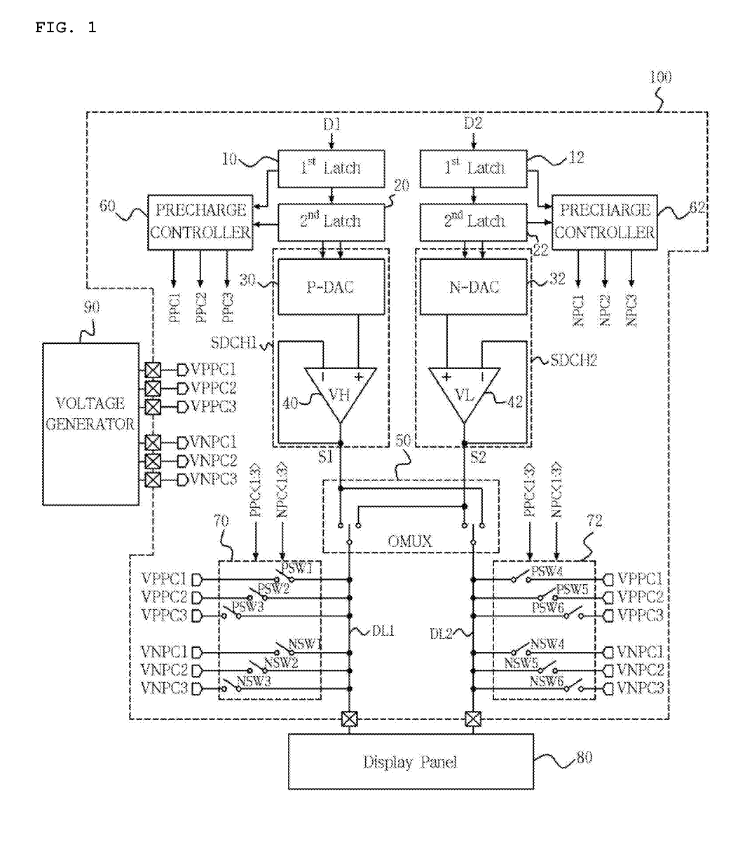

FIG. 1 is a block diagram of a display driving device and a display device including the same according to an embodiment of the present invention. For convenience of description, FIG. 1 exemplifies that a pair of data output lines DL1 and DL2 are driven.

Referring to FIG. 1, the display device according to the present embodiment includes a voltage generator 90, the display driving device 100 and a display panel 80.

The voltage generator 90 generates precharge voltages VPPC1, VPPC2, VPPC3, VNPC1, VNPC2 and VNPC3, and provides the generated precharge voltages to the display driving device 100. The precharge voltages VPPC1, VPPC2, VPPC3, VNPC1, VNPC2 and VNPC3 may be set to levels between supply voltages for driving output buffers 40 and 42 of the display driving device 100.

For example, when the output buffer 40 is driven between supply voltages VDD and HVDD and the output buffer 42 is driven between supply voltages HVDD and VSS, the precharge voltages VPPC1, VPPC2 and VPPC3 are set to levels between the supply voltages VDD and HVDD, and the precharge voltages VNPC1, VNPC2 and VNPC3 are set to levels between the supply voltages HVDD and VSS. The supply voltage HVDD is the average voltage of the supply voltages VDD and VSS. In the present embodiment, each of source driving channels SDCH1 and SDCH2 utilizes six precharge voltages VPPC1, VPPC2, VPPC3, VNPC1, VNPC2 and VNPC3. However, the present embodiment is not limited thereto.

The display driving device 100 converts digital image data D1 and D2 inputted through the source driving channels SDCH1 and SDCH2 into source driving signals S1 and S2, and provides the source driving signals S1 and S2 to the display panel 80, during a first driving period. Furthermore, the display driving device 100 precharges data output lines DL1 and DL2 corresponding to the source driving channels SDCH1 and SDCH2 using one of the precharge voltages VPPC1, VPPC2, VPPC3, VNPC1, VNPC2 and VNPC3, during a second driving period. The first driving period may be defined as a data charging/discharging period in which the source driving signals S1 and S2 corresponding to the digital image data D1 and D2 are provided to the data output lines DL1 and DL2, respectively, and the second driving period may be defined as a precharge period in which the charges of the data output lines DL1 and DL2 are shared or the data output lines DL1 and DL2 are precharged through the precharge voltages VPPC1, VPPC2, VPPC3, VNPC1, VNPC2 and VNPC3.

The display driving device 100 includes first and second latches 10 and 20, a digital-analog converter 30, the output buffer 40, an output switching unit 50, a precharge controller 60 and a precharge switching unit 70, which correspond to the data output line DL1. Furthermore, the display driving device 100 includes first and second latches 12 and 22, a digital-analog converter 32, the output buffer 42, an output switching unit 50, a precharge controller 62 and a precharge switching unit 72, which correspond to the data output line DL2.

The first latch 10 stores digital image data, and the second latch 20 stores digital image data transmitted from the first latch 10. Hereafter, the digital image data stored in the first latch 10 will be referred to as current data, and the digital image data stored in the second latch 20 will be referred to as previous data.

The digital-analog converter 30 provides a source driving signal corresponding to the digital image data to the output buffer 40, and the output buffer 40 buffers the source driving signal, and provides the buffered source driving signal to the output switching unit 50.

The output switching unit 50 transmits the source driving signal to the data output line DL1 or DL2 according to a control signal (not illustrated). The data output lines DL1 and DL2 are connected to source lines (not illustrated) of the display panel 80, respectively.

The precharge controller 60 receives the current data and previous data from the first latch 10 and the second latch 20, respectively, and decides whether to perform a precharge operation, depending on the values of the current data and previous data.

FIG. 1 illustrates that the precharge controller 60 is configured to receive the current data and previous data from the first and second latches 10 and 20, respectively, but the present embodiment is not limited thereto. In another embodiment, the precharge controller 60 may be configured to receive data from the second latch 20. For example, the precharge controller 60 may include a D flip-flop for storing data, and compare the data inputted from the second latch 20 to data stored in the D flip-flop. At this time, the data inputted from the second latch 20 may be defined as current data, and the data stored in the D flip-flop may be defined as previous data.

The precharge controller 60 may decide whether to perform a precharge operation depending on the values of the current data and previous data, and select a precharge voltage suitable for each channel. When the value of the previous data is equal to the value of the current data, the precharge controller 60 may control the precharge switching unit 70 not to perform a precharge operation. When the value of the previous data is different from the value of the current data, the precharge controller 60 may decide to perform a precharge operation, control the precharge switching unit 70 to select a precharge voltage corresponding to the value of the current data, and precharge the data output line DL1 to the selected precharge voltage.

The precharge controller 60 may include a logic block which compares the values of the previous data and current data, and finds a suitable precharge voltage among the positive precharge voltages VPPC1, VPPC2 and VPPC3.

For example, the precharge controller 60 may be configured to receive only two most significant bits when digital image data is 8-bit data. When the two most significant bits of the previous data are equal to the two most significant bits of the current data, the precharge controller 60 may control the precharge switching unit 70 not to perform a precharge operation. On the other hand, when the two most significant bits of the previous data are different from the two most significant bits of the current data, the precharge controller 60 may select one of the precharge voltages VPPC1, VPPC2 and VPPC3 according to the value of the two most significant bits of the current data.

The precharge controller 62 receives current data and previous data from the first and second latches 12 and 22, respectively, and decides whether to perform a precharge operation, depending on the values of the current data and previous data.

The precharge controller 62 controls the precharge switching unit 72 not to perform a precharge operation when the values of the previous data and current data are equal to each other, and precharges the data output line DL2 to a precharge voltage corresponding to the value of the current data when the values of the previous data and current data are different from each other.

The precharge controller 62 compares the values of the previous data and current data, and searches for a suitable precharge voltage among the negative precharge voltages VNPC1, VNPC2 and VNPC3. For example, when the two most significant bits of the previous data are equal to the two most significant bits of the current data, the precharge controller 62 may control the precharge switching unit 72 not to perform a precharge operation. On the other hand, when the two most significant bits of the previous data are not equal to the two most significant bits of the current data, the precharge controller 62 may select one of the negative precharge voltages VNPC1, VNPC2 and VNPC3 according to the value of the two most significant bits of the current data.

The precharge switching unit 70 includes switches PSW1, PSW2 and PSW3 for transmitting the positive precharge voltages VPPC1, VPPC2 and VPPC3 to the data output line DL1 and switches NSW1, NSW2 and NSW3 for transmitting the negative precharge voltages VNPC1, VNPC2 and VNPC3 to the data output line DL1.

The precharge switching unit 72 includes switches PSW4, PSW5 and PSW6 for transmitting the positive precharge voltages VPPC1, VPPC2 and VPPC3 to the data output line DL2 and switches NSW4, NSW5 and NSW6 for transmitting the negative precharge voltages VNPC1, VNPC2 and VNPC3 to the data output line DL2.

The switches PSW1, PSW2, PSW3, PSW4, PSW5 and PSW6 are turned off in response to switch signals PPC1, PPC2 and PPC3, and the switches NSW1, NSW2, NSW3, NSW4, NSW5 and NSW6 are turned off in response to switch signals NPC1, NPC2 and NPC3.

The precharge switching units 70 and 72 transmit any one of the precharge voltages VPPC1, VPPC2, VPPC3, VNPC1, VNPC2 and VNPC3 to the data output lines DL1 and DL2 or not transmit the precharge voltages to the data output lines DL1 and DL2, in response to the switch signals PPC1, PPC2 and PPC3 of the precharge controller 60 and the switch signals NPC1, NPC2 and NPC3 of the precharge controller 62.

The precharge voltages VPPC1, VPPC2, VPPC3, VNPC1, VNPC2 and VNPC3 may be provided from the external voltage generator 90, and the number of precharge voltages may be changed depending on a system condition, and processed through various options depending on an operation for each period and source driving channels participating in a precharge operation.

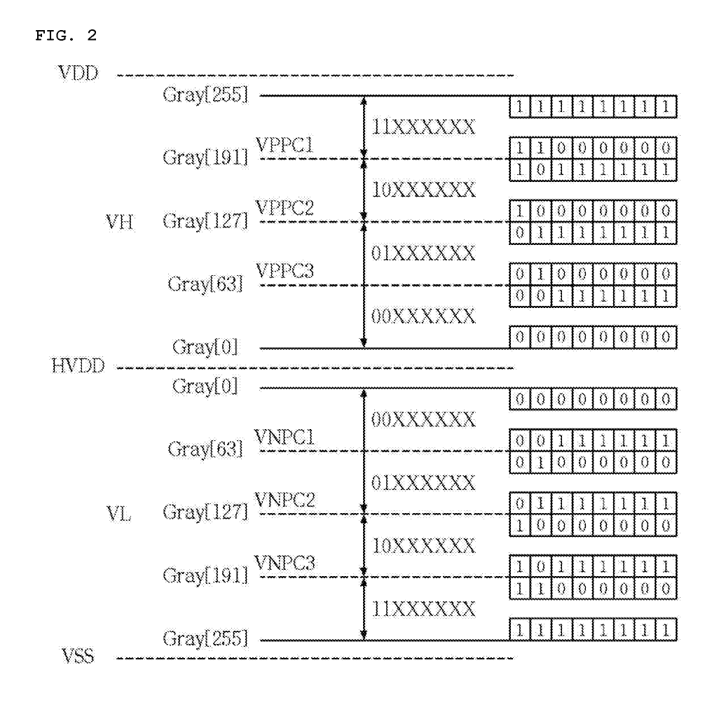

FIG. 2 is a diagram illustrating an example in which the precharge controllers 60 and 62 of FIG. 1 decide a precharge voltage level according to the value of data.

Referring to FIGS. 1 and 2, the precharge controllers 60 and 62 may decide whether to perform a precharge operation or decide the level of a precharge voltage, according to the values of previous data and current data.

The precharge controllers 60 and 62 control the precharge switching units 70 and 72 not to perform a precharge operation when the values of the previous data and current data are equal to each other, and search for the level of the precharge voltage when the values of the previous data and current data are different from each other. The precharge controllers 60 and 62 control the precharge switching units 70 and 72 to select the positive precharge voltage VPPC1 and the negative precharge voltage VNPC3 as the precharge voltages when the two most significant bits of the current data are 11, control the precharge switching units 70 and 72 to select the positive precharge voltage VPPC2 and the negative precharge voltage VNPC2 as the precharge voltages when the two most significant bits of the current data are 10, and control the precharge switching units 70 and 72 to select the positive precharge voltage VPPC3 and the negative precharge voltage VNPC1 as the precharge voltages when the two most significant bits of the current data are 01.

The precharge controller 60 provides to the precharge switching unit 70 the switch signals PPC1, PPC2 and PPC3 for selecting the positive precharge voltage VPPC1 as the precharge voltage when a data value to drive the data output line DL1 corresponds to gray scales [191] to [255], provides to the precharge switching unit 70 the switch signals PPC1, PPC2 and PPC3 for selecting the positive precharge voltage VPPC2 as the precharge voltage when the data value to drive the data output line DL1 corresponds to gray scales [127] to [190], and provides to the precharge switching unit 70 the switch signals PPC1, PPC2 and PPC3 for selecting the positive precharge voltage VPPC3 as the precharge voltage when the data value to drive the data output line DL1 corresponds to gray scales [063] to [127].

The precharge controller 62 provides to the precharge switching unit 72 the switch signals NPC1, NPC2 and NPC3 for selecting the negative precharge voltage VNPC3 as the precharge voltage when a data value to drive the data output line DL2 corresponds to gray scales [191] to [255], provides to the precharge switching unit 72 the switch signals NPC1, NPC2 and NPC3 for selecting the negative precharge voltage VNPC2 as the precharge voltage when the data value to drive the data output line DL2 corresponds to gray scales [127] to [190], and provides to the precharge switching unit 72 the switch signals NPC1, NPC2 and NPC3 for selecting the negative precharge voltage VNPC1 as the precharge voltage when the data value to drive the data output line DL2 corresponds to gray scales [063] to [127].

The number of precharge voltages may be changed depending on a system condition, and processed through various options depending on an operation for each period and source driving channels participating in a precharge operation.

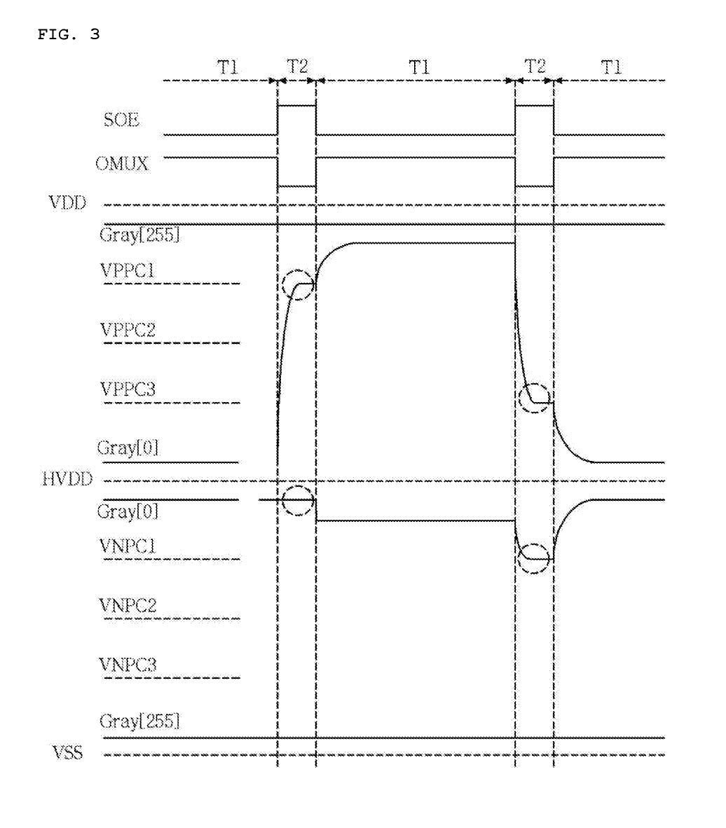

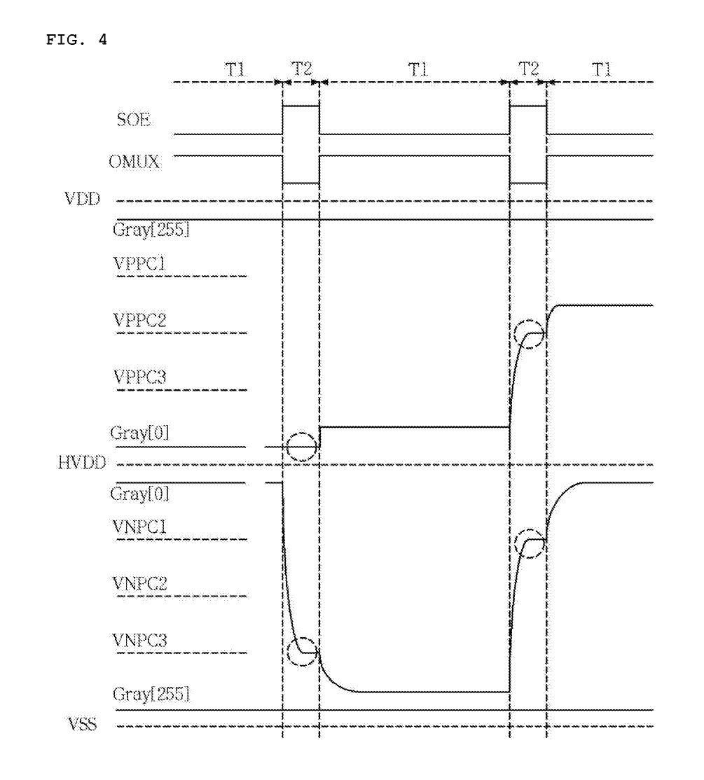

FIGS. 3 and 4 are waveform diagrams for describing the operation of the display driving device according to the embodiment of the present invention.

Referring to FIGS. 3 and 4, the display driving device 100 may provide the source driving signals S1 and S2 corresponding to the digital image data D1 and D2 to the display panel 80 in a first driving period T1, and not perform a precharge operation depending on the values of the previous data and current data of the digital image data or select a suitable precharge voltage among the precharge voltages VPPC1, VPPC2, VPPC3, VNPC1, VNPC2 and VNPC3 according to the value of the current data to drive the data output lines DL1 and DL2.

For example, referring to FIGS. 2 and 3, when the logic level of the most significant bits of the current image data of the digital image data D1 is different from the logic level of the most significant bits of the previous image data in a first high period of a signal SOE and the logic level of the two most significant bits of the current image data is 11, the display driving device 100 precharges the data output line DL1 to the positive precharge voltage VPPC1. According to the present embodiment, the display driving device 100 can select the positive precharge voltage VPPC1 close to the gray scale [255] corresponding to the current image data, and precharge the data output line, thereby reducing power consumption and heat generation.

Furthermore, referring to FIGS. 2 and 3, when the logic levels of the most significant bits of the current image data and previous image data in the digital image data D2 are equal to 00 in the first high period of the signal SOE, the display driving device 100 does not precharge the data output line DL2. In the present embodiment, when the logic levels of the most significant bits of the current image data and previous image data are equal to each other, the display driving device 100 may not use a precharge function on the data output lines DL1 and DL2 corresponding to the source driving channels SDCH1 and SDCH2. Therefore, since an unnecessary precharge function is not performed, power consumption and heat generation can be reduced.

In the present embodiment, when the logic levels of the two most significant bits of the current image data of the current image data and previous image data of the digital image data D1 and D2 are different from each other in a second high period of the signal SOE and the logic level of the most significant bits of the current image data is 00, the display driving device 100 precharges the data output lines DL1 and DL2 to the positive precharge voltage VPPC3 and the negative precharge voltage VNPC1, respectively. As such, the display driving device 100 can select the positive precharge voltage VPPC3 and the negative precharge voltage VNPC1 which are close to the gray scale [0] corresponding to the current image data, and precharge the data output lines DL1 and DL2, respectively, thereby reducing power consumption and heat generation.

For example, referring to FIGS. 2 and 4, when the logic levels of the most significant bits of the current image data and previous image data of the digital image data D1 are equal to 00 in the first high period of the signal SOE, the display driving device 100 does not precharge the data output line DL1. Furthermore, when the logic levels of the most significant bits of the current image data and previous image data of the digital image data D2 are different from each other in the first high period of the signal SOE and the logic level of the most significant bits of the current image data is 11, the display driving device 100 precharges the data output line DL2 to the negative precharge voltage VNPC3.

Furthermore, when the logic levels of the most significant bits of the current image data and previous image data of the digital image data D1 are different from each other in the second high period of the signal SOE and the logic level of the most significant bits of the current image data is 10, the display driving device 100 precharges the data output line DL1 to the positive precharge voltage VPPC2. Furthermore, when the logic levels of the two most significant bits of the current image data and previous image data of the digital image data D2 are different from each other in the second high period of the signal SOE and the logic level of the two most significant bits of the current image data is 00, the display driving device 100 precharges the data output line DL2 to the negative precharge voltage VNPC1.

As such, since the display driving device 100 according to the present embodiment decides whether to perform a precharge operation on each source driving channel depending on the varied value of the digital image data, the display driving device 100 can prevent an unnecessary precharge operation, thereby reducing power consumption. Furthermore, since the display driving device 100 decides the level of the precharge voltage suitable for each source driving channel depending on the varied value of the digital image data, the display driving device 100 can reduce the swing of the source driving signal, thereby reducing power consumption and heat generation.

In order to maximize or optimize the effect of the precharge operation, the display driving device 100 can change the active time of the signal SOE. The display driving device 100 may secure a sufficient precharge time by increasing the active time of the signal SOE depending on the values of the previous data and current data. For example, when a difference between the gray scale corresponding to the previous data and the gray scale corresponding to the current data exceeds a preset reference value, the display driving device 100 may increase the precharge time by a preset time in order to maximize the effect of the precharge operation. Furthermore, the display driving device 100 may vary the active time of the signal SOE depending on the difference between the gray scale corresponding to the previous data and the gray scale corresponding to the current data. Since the precharge time is varied depending on the varied value of the image data, the precharge effect can be maximized.

According to the present embodiment, the digital image data stored in the latches are sensed. However, the present embodiment is not limited thereto, but the display driving device 100 can sense the value of the source driving signal corresponding to the digital image data, and control the precharge operation according to the value of the source driving signal. For example, the display driving device 100 may periodically sense a change of the source driving signal outputted from the digital-analog converter or output buffer, and not perform a precharge operation when the values of the previous source driving signal and the present source driving signal are not changed, or decide the level of the precharge voltage according to the level of the next source driving signal when the source driving signal is changed.

Furthermore, when the present embodiment is applied to a light emitting display device, power consumption can be reduced through a simpler mechanism than a liquid crystal display device. Since an OLED panel of the light emitting display device has no polarity, the positive precharge voltage and the negative precharge voltage do not need to be distinguished from each other. Therefore, only the level of the precharge voltage may be decided according to the value of data to drive the data output line, and the logic block of the precharge control unit may be configured through a simpler mechanism than the liquid crystal display device.

While various embodiments have been described above, it will be understood to those skilled in the art that the embodiments described are by way of example only. Accordingly, the disclosure described herein should not be limited based on the described embodiments.

What is claimed is:

1. A display driving device comprising:
a source driving channel configured to provide a source driving signal corresponding to image data;
a precharge unit configured to precharge a data output line of the source driving channel by selecting one of precharge voltages; and
a precharge controller configured to decide whether to perform a precharge operation on the source driving channel depending on a variation of the image data, and control the precharge unit to select one of the precharge voltages when the performance of the precharge operation is decided.

2. The display driving device of claim 1, wherein the precharge controller compares current image data and previous image data, and decides whether to perform the precharge operation based on the comparison result.

3. The display driving device of claim 1, wherein the precharge controller controls the precharge unit to select a precharge voltage closest to a gray scale corresponding to the image data which are to be applied to the source driving channel.

4. The display driving device of claim 1, wherein the precharge controller disables the precharge unit when the logic level of most significant bits of the current image data is equal to the logical level of most significant bits of the previous image data.

5. The display driving device of claim 4, wherein the precharge controller controls the precharge unit to select one of the precharge voltages according to the logic level of the most significant bits of the current image data, when the logic level of the most significant bits of the current image data is different from the logic level of the most significant bits of the previous image data.

6. The display driving device of claim 1, wherein the precharge unit comprises switches corresponding one-to-one to the precharge voltages, and
the switches are selectively enabled by the precharge controller, and transmit one of the precharge voltages to the data output line.

7. A display device comprising:
a voltage generator configured to generate precharge voltages;
source driving channels each comprising a digital-analog converter configured to convert image data into a source driving signal and an output buffer configured to output the source driving signal to a data output line;
a precharge unit configured to precharge the data output line by selecting one of the precharge voltages; and
a precharge controller configured to decide whether to perform a precharge operation on each of the source driving channels depending on a variation of the image data, and control the precharge unit to select one of the precharge voltages when the performance of the precharge operation is decided.

8. The display device of claim 7, wherein the voltage generator generates the precharge voltages having levels between supply voltages for driving the output buffer, and provides the precharge voltages to the precharge unit.

9. The display device of claim 7, wherein the precharge unit comprises switches corresponding one-to-one to the precharge voltages and installed at each of the source driving channels, and
the switches are selectively enabled by the precharge controller, and transmit one of the precharge voltages to the data output line.

10. The display device of claim 7, wherein the precharge controller decides whether to perform a precharge operation depending on the logic level of most significant bits of current image data and the logic level of most significant bits of previous image data, and decides the level of the precharge voltage according to the logic level of most significant bits of the current image data when the performance of the precharge operation is decided.

11. A display driving device comprising:
a source driving channel configured to provide a source driving signal corresponding to image data in a first driving period;
a precharge controller configured to compare the logic level of most significant bits of current image data to the logic level of most significant bits of previous image data in a second driving period, decide whether to perform a precharge operation based on the comparison result, and provide a precharge control signal for selecting a precharge voltage closest to a gray scale corresponding to the current image data when the performance of the precharge operation is decided; and
a precharge unit configured to select one of precharge voltages in response to the precharge control signal, and precharge a data output line corresponding to the source driving channel to the selected precharge voltage.

12. The display driving device of claim 11, wherein the precharge controller varies an active time of the second driving period according to a difference between current and previous values corresponding to the image data.

13. The display driving device of claim 12, wherein the precharge controller increases the active time of the second driving period when the difference between the current and previous values corresponding to the image data is equal to or more than a preset reference value.

14. The display driving device of claim 11, wherein the precharge controller disables the precharge unit when the logic level of most significant bits of the current image data is equal to the logical level of most significant bits of the previous image data.

15. The display driving device of claim 14, wherein the precharge controller controls the precharge unit to select one of the precharge voltages according to the logic level of the most significant bits of the current image data, when the logic level of the most significant bits of the current image data is different from the logic level of the most significant bits of the previous image data.
